(19) United States
(12) Patent Application Publication
(10) Pub. No.: US 2010/0052982 A1
(43) Pub. Date: Mar. 4, 2010

(54) GPS DEVICE WITH SECURITY FUNCTION AND MEHOD THEREOF

(75) Inventors: HSIN-NAN HU, Tu-Cheng (TW); CHAO-FENG MA, Shenzhen City (CN); KUAN-HONG HSIEH, Tu-Cheng (TW); XIAO-GUANG LI, Shenzhen City (CN)

Correspondence Address: PCE INDUSTRY, INC.;ATT. Steven Reiss, 288 SOUTH MAYO AVENUE, CITY OF INDUSTRY, CA, 91789, US

(73) Assignees: HONG FU JIN PRECISION INDUSTRY (Shenzhen) Co., LTD., Shenzhen City (CN); HON HAI PRECISION INDUSTRY CO., LTD., Tu-Cheng (TW)

(21) Appl. No.: 12/432,696

(22) Filed: Apr. 29, 2009

(30) Foreign Application Priority Data
Aug. 28, 2008 (CN) 200810304265.5

(51) Int. Cl. G06F 7/00; G06F 19/00; G01S 5/02; H04B 7/185

(52) U.S. Cl. 342/357.07; 701/36

(57) ABSTRACT

This present disclosure provides a GPS device with security function and method for the same. The GPS device includes a communications unit configured to transmit communication data between the GPS device and at least one external controlled device, at least one motion sensing unit, the method includes steps of: detecting current motion state of a vehicle, and obtaining sensing information; generating a first control signal to an external controlled device, when determining the vehicle is in a defined particular motion state; transmitting the first control signal to turn on the controlled device through the communications unit; generating a second control signal to the controlled device, when determining the vehicle isn't the particular motion state; transmitting the second control signal to turn off the controlled device through the communications unit.

### BACKGROUND

1. Technical Field

The present disclosure relates to global positioning system (GPS) devices and, especially, to a GPS device having a security function and a method for the security function.

2. Description of Related Art

Usually, a vehicle navigation apparatus determines a current location of the vehicle using GPS data, and provides static information such as speed limits along chosen routes, gas station locations, known traffic speed monitoring locations etc. Sometimes, it is needed to provides dynamic information such as live feed and security function, for example, when turning action, reversing, speeding, sudden acceleration, collision, turn over, being stolen and so on.

### BRIEF DESCRIPTION OF THE DRAWINGS

The components in the drawings are not necessarily drawn to scale, the emphasis instead being placed upon clearly illustrating the principles of the GPS device and the method with security function. Moreover, in the drawings, like reference numerals designate corresponding parts throughout the several views.

FIG. 1 is a block diagram of a hardware infrastructure of a GPS device with security function in accordance with an exemplary embodiment.

FIG. 2 is a block diagram of functional modules of a central processing unit (CPU) of the GPS system of FIG. 1, in accordance with an exemplary embodiment.

FIG. 3 is a flowchart of method of security function implemented by the GPS device of FIG. 1, in accordance with an exemplary embodiment.

### DETAILED DESCRIPTION OF THE EMBODIMENTS

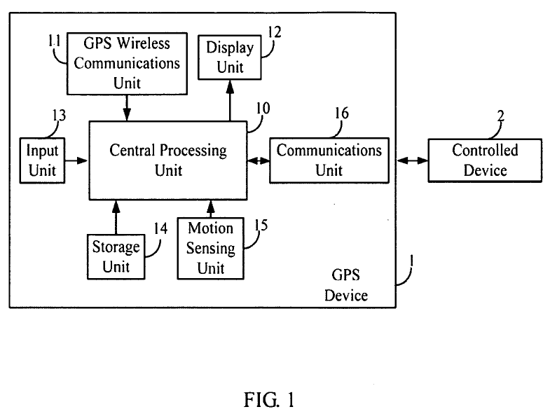

Referring to FIG. 1, a GPS device 1 communicates with at least one controlled device 2 through a communications unit 16. In order to make the disclosure clearer, only one controlled device 2 is taken for example in the following description. The communications unit 16 may be a wireless communication unit, such as one based on BLUETOOTH, and may alternatively be a wired communication unit, such as one based on RS232 standard.

The controlled device 2 is configured to receive and execute control signals from the GPS device 1. The controlled device 2 may be, but is not limited to, a video device, a turning lamp, a backup light, a speed reducer, a prompt unit, etc.

The GPS device 1 includes a central processing unit (CPU) 10, a GPS wireless communications unit 11, a display unit 12, an input unit 13, a storage unit 14, a motion sensing unit 15, and the communications unit 16.

The GPS wireless communications unit 11 is configured to receive navigation signals in real time, and transmit the navigation signals to the CPU 10. The display unit 12 is configured to display live feed or navigation information according to the navigation signals. The input unit 13 is configured to receive user input operations. The storage unit 14 is configured to store a plurality of sensing parameters and control signals. The control signals are transmitted to the controlled device 2.

The motion sensing unit 15 includes at least one sensor for sensing a current motion state of the vehicle, and generating a corresponding sensing signal for indicating the current motion state of the vehicle. The sensor may be, for example, but is not limited to, a vehicle speed sensor for detecting a vehicle speed, a gyroscope (GYRO) sensor for detecting an attitude of the body of the vehicle, a steering sensor for detecting a vehicle steering rudder, or a vertical acceleration sensor for detecting a vertical acceleration of the vehicle.

The CPU 10 is configured to receive the sensing signals from the motion sensing unit 15, and analyze the sensing signals to filter out noise and obtain sensing information. The CPU 10 is further configured to compare the sensing information with predetermined sensing parameters, therein the predetermined sensing parameters are divided into subsets, each subset contains one or more parameters associated with a particular motion state of the vehicle, for example, turning left, turning right, reversing, speeding, sudden acceleration, collision, turn over, being stolen and so on. When the sensing information satisfies the predetermined sensing parameters, namely the sensing information satisfies a subset of the predetermined sensing parameters or is in a predetermined range of one of the subsets of the predetermined sensing parameters, the CPU 10 may determines the current motion state of the vehicle accordingly.

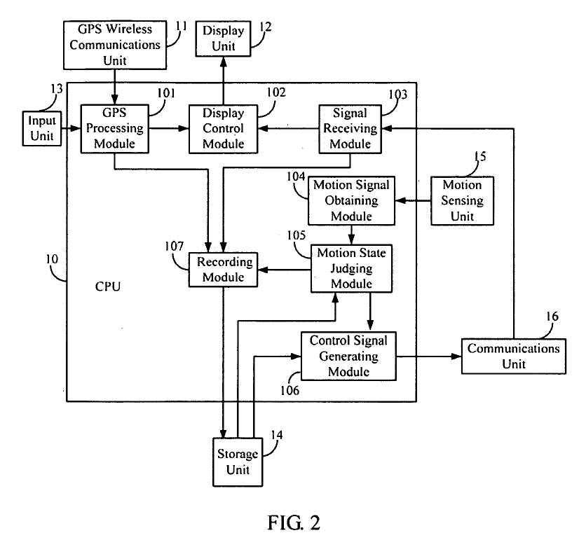

Referring to FIG. 2, the CPU 10 includes a GPS processing module 101, a display control module 102, a signal receiving module 103, a motion signal obtaining module 104, a motion state judging module 105, a control signal generating module 106, and a recording module 107.

The GPS processing module 101 is configured to determine navigation information according to the navigation signals from the GPS wireless communications unit 11 and the input information from the input unit 13. The navigation information includes, but is not limited to, the current location of the vehicle and the route. The display control module 102 automatically switches the display unit 12 to display the live feed when the live feed is received and switches back when the live feed ends. The signal receiving module 103 is configured to send the received signals to the display control module 102 and the recording module 107.

The motion signal obtaining module 104 is configured to obtain the sensing signals which are detected from the motion sensing unit 15, filter out noise from the sensing signal to obtain sensing information of the motion sensing unit 15, and send the sensing information to the motion state judging module 105. The motion state judging module 105 is configured to compare the sensing information with predetermined sensing parameters, determine a particular motion state when the sensing information satisfies a subset of the predetermined sensing parameters, send the determined particular motion state to the control signal generating module 106 and the recording module 107.

The control signal generating module 106 is configured to generate and send control signals to the controlled device 2 through the communications unit 16 according to the particular motion state. The recording module 107 is configured to save a particular state record that includes, but is not limited to, a current location obtained from the GPS processing module 101, a start time of the particular motion state, and the particular motion state from the motion state judging module 105.

When the controlled device 2 includes a video device, the particular state record further includes a record of the live feed provided by the video device. When the controlled device 2 includes turning lamps, the turning lamps, corresponding to turning direction, are turned on when the motion state judging module 105 determines the particular motion state is turning. When the controlled device 2 includes backup lights, the appropriate backup lights are turned on when the motion state judging module 105 determines the particular motion state is reversing. When the controlled device 2 includes one speed reducer, the speed reducer reduces speed of the vehicle when the motion state judging module 105 determines the particular motion state is speeding. When the controlled device 2 includes one prompt unit, the control signal generating module 106 further generates control signals of the particular motion state to the appropriate prompt unit. In an exemplary embodiment, the prompt unit may be indicator lamps that are disposed at appropriate position of the GPS device 1, the appropriate indicator lamp is flashed during turning maneuvers in response to the control signal. In another exemplary embodiment, the prompt unit may be a speaker that can output voice commands such as “turn left, attention please!” during turning maneuvers in response to the control signal.

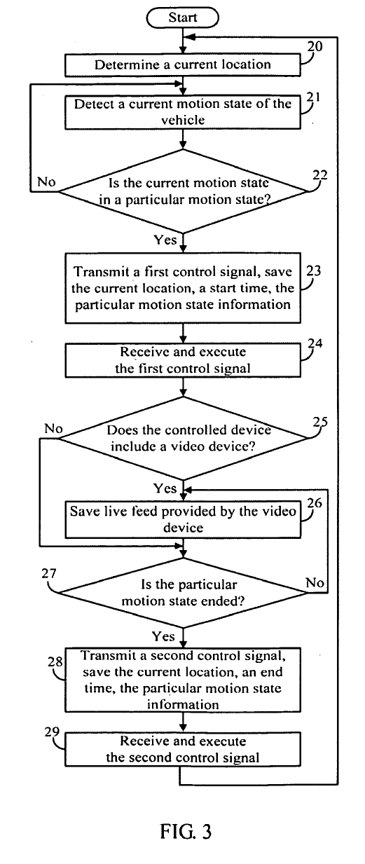

FIG. 3 is a flowchart of security method implemented by the GPS device 1 of FIG. 1.

In step 20, the GPS processing module 101 determines a current location of the vehicle according to the navigation signals received by the GPS wireless communications unit 11. The GPS wireless communications unit 11 receives GPS satellite navigation signals in real time.

In step 21, the motion sensing unit 15 detects the current motion state of the vehicle and generates sensing signals, and sends the sensing signals to the motion signal obtaining module 104. The motion signal obtaining module 104 filters noise from the sensing signals to obtain sensing information of the motion sensing unit 15, and sends the current sensing information to the motion state judging module 105.

In step 22, the motion state judging module 105 compares the sensing information with the predetermined sensing parameters, determines a particular motion state when the sensing information satisfies a subset of the predetermined sensing parameters, sends the determined particular motion state to the control signal generating module 106 and the recording module 107. When the motion state judging module 105 determines the vehicle isn't a particular motion state, the procedure returns to step 21.

In step 23, the control signal generating module 106 generates and sends a first control signal to turn on a controlled device 2. The recording module 107 obtains the current location of the vehicle from the GPS processing module 101, and saves a particular state record in the storage unit 14. The particular state record includes the current location, the start time of the particular motion state, and the particular motion state.

In step 24, the controlled device 2 is turned on in response to the first control signal.

In step 25, the control signal generating module 106 determines whether the controlled device includes a video device. If yes, then go to step 26, if not, the procedure goes to step 27.

In step 26, the signal receiving module 103 receives live feed which is provided by the video device through the communications unit 16, and the display control module 102 switches the display unit 12 to display the live feed, the recording module 107 saves the live feed in the particular state record.

In step 27, when the sensing information does not satisfy the predetermined sensing parameters, namely the vehicle is not in the particular motion state, the motion state judging module 105 transmits the judgment result to the control signal generating module 106 and the recording module 107. When the motion state judging module 105 determines the vehicle is still in the particular motion state, the procedure repeats the step 26.

In step 28, the control signal generating module 106 generates and sends a second control signal to turn off the controlled device 2 through the communications unit 16, the recording module 107 obtains the current location of the vehicle from the GPS processing module 101, and saves another particular state record in the storage unit 14. The particular state record further includes the current location, an end time of the particular motion state, and the particular motion state. Then the procedure returns to step 20.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A global position system (GPS) device with a security function comprising:
a GPS wireless communications unit configured to receive GPS satellite navigation signal in real time;
a communications unit configured to transmit communication data between the GPS device and at least one external controlled device;
at least one motion sensing unit configured to obtain appropriate sensing signals at a current motion state;
a motion signal obtaining module configured to obtain the sensing signals which are detected from the motion sensing unit, and obtain sensing information from the sensing signals;
a motion state judging module configured to compare the sensing information with predetermined sensing parameters, and determine a particular motion state when the sensing information satisfies a subset of the predetermined sensing parameters;
a control signal generating module configured to generate and send control signals of the particular motion state to the appropriate controlled device through the communications unit according to the particular motion state.

2. The GPS device as described in claim 1, further comprising a recording module, wherein the recording module is configured to connect with a storage unit and save a particular state record to the storage unit, the storage unit being configured to connect with the motion state judging module and the control signal generating module, and the particular state record includes a current location obtain from the GPS processing module, a start time or an end time of the particular motion state and the particular motion state when the vehicle is in a particular motion state.

3. The GPS device as described in claim 2, the controlled device further comprises at least one video device, and a signal receiving module, the signal receiving module configured to receive live feed which is transmitted through the communications unit, the particular state record further comprises the live feed.

4. The GPS device as described in claim 1, further comprising a display control module, the display control module configured to switch a display unit to display the live feed when the live feed is received and switch back when the live feed ends.

5. The GPS device as described in claim 2, the controlled device further comprises at least one turning lamp, the turning lamps in corresponding to turning direction are turned on when the motion state judging module determines the particular motion state is turning.

6. The GPS device as described in claim 1, the controlled device further comprises at least one backup light, the appropriate backup lights are turned on when the motion state judging module determines the particular motion state is reversing.

7. The GPS device as described in claim 1, the controlled device further comprises at least one speed reducer, the appropriate speed reducer reduce speed when the motion state judging module determines the particular motion state is speeding.

8. The GPS device as described in claim 1, the controlled device further comprises at least one prompt unit, the control signal generating module further generates control signal of the particular motion state to the appropriate prompt units.

9. A security method used in a GPS device, the GPS device comprises a communications unit configured to transmit communication data between the GPS device and at least one external controlled device, at least one motion sensing unit, the method comprising:
detecting current motion state of a vehicle, and obtaining sensing information;
generating a first control signal to an external controlled device, when determining the vehicle is in a defined particular motion state;
transmitting the first control signal to turn on the controlled device through the communications unit;
generating a second control signal to the controlled device, when determining the vehicle isn't the particular motion state;
transmitting the second control signal to turn off the controlled device through the communications unit.

10. The method as described in claim 9, further comprising:
saving a particular state record which includes a current location obtained from the GPS processing module, a start time of the particular motion state and the particular motion state, when determining a defined particular motion state.

11. The method as described in claim 9, further comprising:
saving another particular state record which includes a current location obtained from the GPS processing module, an end time of the particular motion state and the particular motion state, when determining the vehicle isn't the particular motion state.

12. The method as described in claim 9, further comprising:
switching to display live feed when the live feed is received and switching back when the live feed ends, and the live feed is recorded in the particular state record.
